(19) United States
(12) Patent Application Publication
(10) Pub. No.: US 2025/0371158 A1
(43) Pub. Date: Dec. 4, 2025

(54) APPARATUS AND METHOD FOR UPDATING SECURITY DATA STORED IN A MEMORY OF A MICROCONTROLLER

(71) Applicant: STMicroelectronics International N.V., Geneva (CH)

(72) Inventor: Jawad Benhammadi, Pont de Claix (FR)

(21) Appl. No.: 19/208,280

(22) Filed: May 14, 2025

(30) Foreign Application Priority Data
May 29, 2024 (FR) FR2405544

(51) Int. Cl. G06F 21/57; G06F 21/60; G06F 21/79

(52) U.S. Cl. CPC G06F 21/572; G06F 21/602; G06F 21/79

(57) ABSTRACT

The present description concerns a method of updating a security data stored in a first sector of a non-volatile memory of a microcontroller, with a first status being assigned to the first sector. The method comprises the following successive steps: erasing the content of a second sector of the non-volatile memory, different from the first sector, writing a new version of the security data into the second sector, and assigning the first status to the second sector.

### CROSS-REFERENCE TO RELATED APPLICATIONS

This application claims priority to French Application No. FR2405544, filed on May 29, 2024, which application is hereby incorporated herein by reference.

### TECHNICAL FIELD

The present disclosure generally concerns methods of updating security data in non-volatile memories of a microcontroller, as well as microcontrollers implementing these methods.

### BACKGROUND

Security data stored in microcontroller memories must be updateable. Current update procedures may have weaknesses in terms of robustness, for example regarding a power failure of the microcontroller.

### SUMMARY

There exists a need to improve methods of updating security data of microcontrollers.

An embodiment overcomes all or part of the disadvantages of known methods.

An embodiment provides a method of updating a security data item stored in a first sector of a non-volatile memory of a microcontroller, a first status being assigned to the first sector, the method comprising the following successive steps: erasing the content of a second sector of the non-volatile memory, different from the first sector; writing a new version of the security data item into the second sector; and assigning the first status to the second sector.

An embodiment provides a microcontroller comprising a memory having a first memory sector and a second memory sector different from the first sector, a security data item to be updated being stored in the first sector, a first status being assigned to the first sector, the microcontroller being configured to successively: erase the content of the second memory sector; write a new version of the security data item into the second sector; and assign the first status to the second sector.

According to an embodiment, each sector comprises a plurality of security data.

According to an embodiment, after having written the new version of the security data item into the second sector and, before assigning the first status to the second sector, the security data stored in the first sector are sequentially copied into the second sector.

According to an embodiment, the copying of the security data from the first sector into the second sector is implemented by a state machine.

According to an embodiment, the first sector and the second sector comprise memory spaces each referenced by an address index, the security data of the first sector being each stored in one of the memory spaces of the first sector, and being each copied into the second sector if the memory space of the second sector, having an address index corresponding to the address index of the memory space associated with the security data item of the first sector to be copied, is blank.

According to an embodiment, the erasing of the content of the second sector is implemented by a memory control circuit as a result of the first software command.

According to an embodiment, the writing of the new version of the security data item into the second sector is implemented by the control circuit as a result of a second software command.

According to an embodiment, a second status is assigned to the first sector once the first status has been assigned to the second sector.

According to an embodiment, prior to the update, the first status is assigned to the first sector and the second status is assigned to the second sector.

According to an embodiment, each memory sector comprises a space dedicated to the storage of the status assigned to the sector.

According to an embodiment, only the memory sector assigned the first status is read from.

According to an embodiment, the security data item(s) are encryption keys.

An embodiment provides a system comprising a microcontroller such as described hereabove and an update unit external to the microcontroller, the update unit being configured to transmit, to the microcontroller and during an update, the new version of the security data item.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an example of a microcontroller of the type to which the described embodiments apply;

FIG. 2 illustrates an example of the microcontroller of FIG. 1;

FIG. 3 shows a method of operation of the microcontroller of FIG. 1 according to an example; and

FIG. 4 shows a method of operation of the microcontroller of FIG. 1 according to an embodiment.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

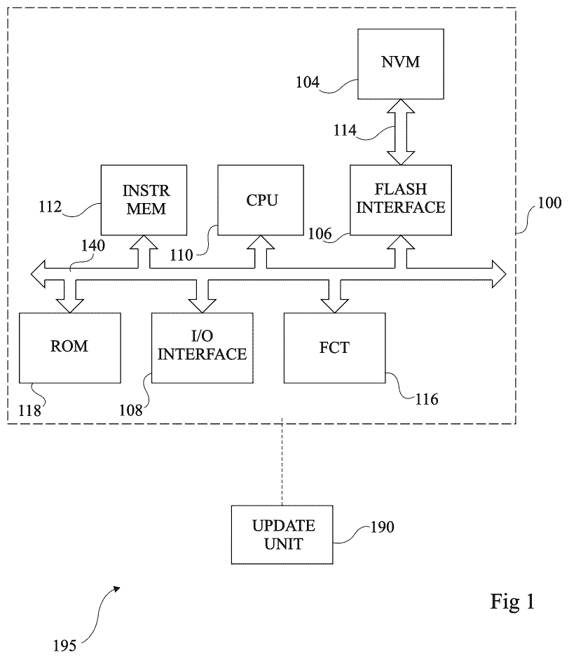

FIG. 1 shows, very schematically and in the form of blocks, an example of a microcontroller 100 of the type to which the described embodiments apply. Circuit 100 is, for example, a microcontroller.

Microcontroller 100 comprises a non-volatile memory 104 (NVM), for example of FLASH or phase-change memory type, capable of communicating, via a communication bus 114, with a non-volatile memory interface 106 (NVM INTERFACE) configured to write or read data into and from non-volatile memory 104.

Circuit 100 further comprises, for example, a processing unit 110 (CPU) comprising one or a plurality of processors under control of instructions stored in an instruction memory 112 (INSTR MEM). Instruction memory 112 is, for example, a volatile random access memory (RAM). Processing unit 110 and memory 112 communicate, for example, via a system (data, address, and control) bus 140. FLASH memory 104 is coupled to system bus 140 via non-volatile memory interface 106 and via bus 114. Device 100 further comprises an input/output interface 108 (I/O interface) coupled to system bus 140 to communicate with the outside.

Device 100 may integrate other circuits implementing other functions (for example, one or a plurality of volatile and/or non-volatile memories, or other processing units), symbolized by a block 116 (FCT) in FIG. 1. Among these other circuits, circuit 100 for example comprises a read-only or static memory 118 (ROM).

Memory 104 for example contains security data, that is, data such as security keys or sensitive data, which are linked, for example, to options selected by the user (Option Bytes Keys) of the microcontroller. It may be useful to update some of these security data.

In the shown example, an update unit 190, external to microcontroller 100, is configured to transmit, to microcontroller 100 and during an update, a new version of the security data to be updated. This transmission may be wired or wireless (Over The Air, OTA). The update unit and microcontroller 100 form a system 195.

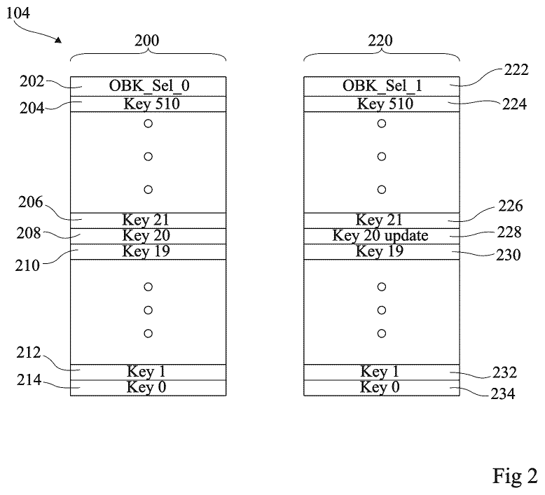

FIG. 2 shows an example of the microcontroller of FIG. 1.

More particularly, the example of FIG. 2 illustrates an example of memory 104. In this example, memory 104 comprises a first and a second memory sectors 200, 220.

Each of these two memory sectors 200,220 comprises memory spaces 202, 204, 206, 208, 210, 212, 214, 222, 224, 226, 228, 230, 232, and 234. Other intermediate memory spaces are present but not shown for reasons of clarity.

The memory spaces are each referenced by an address index Addr_index. Prior to a copying step described in other drawings, security data Key 0, Key 1, . . . , Key 19, Key 20, Key 21, . . . , Key 510, of the first sector 200 are each respectively stored into one of the memory spaces of the first sector of corresponding index. For example, security data item Key o is stored in the memory space of index 0.

Memory spaces 202 and 222 respectively contain a value, for example a byte linked to a register, representative of a read status of the memory sector in which it is stored. In the shown example, the memory space 202 of the first sector 200 has value OBK_Sel_0. This value for example results in that the first sector is not read from when a security data item is requested. In the shown example, the memory space 222 of the second sector 2220 has value OBK_SEL_1. This value for example results in that the second sector is that which is read from when a security data item is requested.

In an example, a value OBK_SEL_2 for example results in that the corresponding sector is that which is read from when a security data item is requested.

When one of the security data items, for example in the shown example, the data item Key 20 of the memory space 208 of sector 200, is updated, it is updated in the other sector, that is, sector 220, which is referred to as the alternate sector. Then, once the update has been carried out, the status of the alternate sector is changed so that it becomes the current sector, that is, that which is read when a security data item is requested. For this purpose, the memory space 228 of corresponding index in the other sector 220 first is erased. In an example, the entire sector 220, that is, all the memory spaces dedicated to security data, is for example erased, and not just memory space 228. Then, the new version of the security data item, Key_20_update, is written into sector 228, for example as a result of a software command implemented with memory interface 106. The still valid security data are then copied from sector 200 into the second sector 220, in the memory spaces of respective indexes, except for the memory space 228 where the data item has been updated.

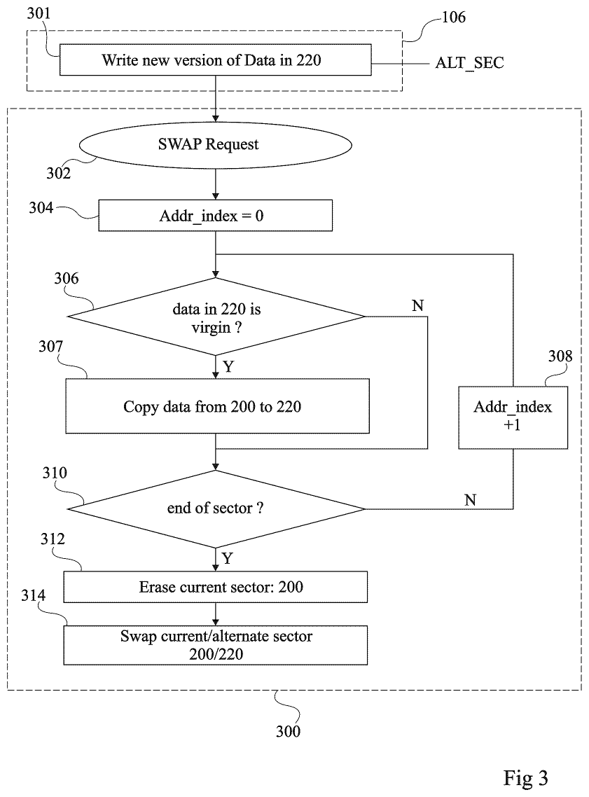

FIG. 3 shows an example of operation of the circuit of FIG. 1 according to an example.

More particularly, the shown example illustrates a method of update of one of the security data, such as for example data item Key 20 as in the previous drawing.

In this example, at the beginning of the method, sector 200 is the current sector, that is, the sector which is read from when a security data item is necessary, and sector 220 is the alternate sector. In other words, at the beginning of the method, the value of the memory space dedicated to the read status of sector 200 is OBK_Sel_1 or OBK_Sel_2, and the value of the memory space dedicated to the read status of sector 220 is OBK_Sel_0.

In this example, sector 220 is empty at the beginning of the method, that is, the memory spaces dedicated to security data have been previously erased during a previous execution of the method, as will be described hereafter.

In a first step 301 (Write new version of Data in 220), the new version of the security data item to be updated is written into the second sector 220, for example with a software command implemented with memory interface 106 via the reading from a register ALT_SECT. The writing is performed into the memory space having the same memory index as the memory space containing the data item to be updated in sector 200. In an example, this writing is performed directly via a bitmap linked to sectors 200 and/or 220.

In the rest of the method, steps 302, 304, 306, 307, 308, 310, 312, and 314 are implemented by a state machine 300, for example implemented in the memory interface or in a circuit of microcontroller 100.

At the next step 302 (SWAP Request), a copy of the data of sector 200 which are valid, that is, which have not been updated, begins.

At the next step 304 (Addr_index=0), the copying starts with the memory space having memory address index 0.

At the next step 306 (data in 220 is virgin?), state machine 300 verifies whether the memory space having address index 0 is empty in sector 220.

If yes (Y branch), step 307 (Copy data from 200 to 220) is performed, and if no (N branch), step 310 (End of sector?) is implemented.

Step 307 consists in copying the security data item present in the index of sector 200, having as a value that at the Y output of step 306, into the memory space having the same index in sector 220.

For the memory space of sector 220 having as an index 228 that of the updated data item Key_20_update, step 306 returns a negative result (N branch) because the data item is already present in sector 220 before the copying of the other data originating from sector 200. This N branch is followed by step 310.

At step 310, if (Y branch) the address index corresponds to the value of the last address index relative to security data of sector 220, then step 312 (Erase current sector: 200) is implemented. In the opposite case, step 308 is implemented.

Step 308 (Addr_index+1) consists in incrementing by one the address index value Addr_index, which then becomes Addr_index+1.

At step 312 (Erase current sector: 200), sector 200, which is the current sector, is erased by state machine 300. In other words, the state machine erases the memory spaces in sector 200 which are dedicated to security data, that is, the memory space dedicated to the read status is not erased.

Then, at step 314 (Swap current/alternate sector 220/220), the status of sector 200 is assigned to sector 220. In other words, state machine 300 changes the value OBK_Sel_1 of sector 200 into value OBK_Sel_0 and the value OBK_Sel_0 of sector 200 into value OBK_Sel_1. At the end of the method of FIG. 3, sector 220 becomes the current sector and sector 200 becomes the alternate sector.

In this example of a method, the state machine carries out all steps 302 to 314. This makes the microcontroller vulnerable, because if a power failure or a resetting of microcontroller 100 occurs between steps 312 and 314, then the change of status of the sectors will not have been performed, but the current sector, that is, sector 200, will already have been erased or corrupt. During the restarting, the current sector 200 will be read from, except that it now contains either no data or corrupt data.

It should be noted that, in an embodiment, step 312 cannot be implemented between steps 302 and 304, since it is necessary to copy the valid security data from sector 200 into sector 220, and that the valid data must be kept in the current sector 200 as long as the copying is not complete, that is, as long as step 310 has not implemented the associated Y branch.

A possible solution is to verify, at each restarting, whether at least one of the steps 302 to 314 implemented by the state machine has been interrupted during the resetting. If so, a load option byte will be issued to update the memory space of sector 200 linked to the read status to OBK_Sel_0. However, this has the disadvantage of having to be implemented at the starting of each application.

The embodiments described hereafter provide overcoming these disadvantages by implementing a method of update of a security data item stored in the first sector 200, a first status (OBK_Sel_1 or OBK_Sel_2) being assigned to the first sector 200, the method comprising the following successive steps: erasing the content of the second memory sector 220, writing a new version of the security data item into the second sector 220; and assigning the first status (OBK_Sel_1 or OBK_Sel_2) to the second sector 220.

This enables not to lose existing keys even though a resetting or a power loss has occurred before the read status of the sectors is changed.

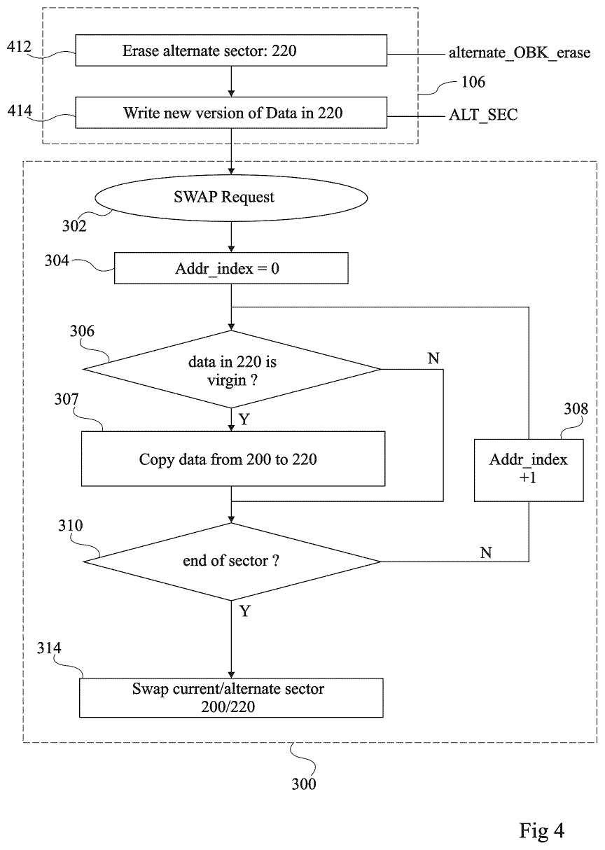

FIG. 4 shows a method of operation of the microcontroller of FIG. 1 according to an embodiment.

More particularly, the shown example illustrates a method of updating one of the security data, for example data item Key 20 as in the previous drawing.

In this example, at the beginning of the method, sector 200 is the current sector and sector 220 is the alternate sector.

At a first step 412 (Erase alternate sector: 220), sector 220, which is the alternate sector (OBK_Sel_0), has its contents dedicated to security data erased, for example by memory interface 106, as a result of a software command (alternate_OBK_erase).

At a next step 414 (Write new version of Data in 220), the new version of security data item Key 20 update is copied into sector 220, for example with memory interface 106, as a result of another software command (ALT_SEC). In an example, this writing is directly performed via a bitmap linked to sectors 200 and/or 220.

After step 414, steps 302, 304, 306, 307, 308, 310, and 314 are implemented similarly to those of FIG. 3, except that step 312 is no longer present and, in step 310, when the Y branch is taken, then step 314 is directly implemented without for step 312 to be executed.

This allows, if a power loss, or a resetting, occur during erase step 414, for this not to impact the operation of the state machine which implements steps 302, 304, 306, 307, 308, 310, and 314. Thus, if a power loss, or a resetting, occur during the implementation of steps 302, 304, 306, 307, 308, 310, and 314 of FIG. 4, then the current sector is still valid since there is no further erasing of the current sector in the steps implemented by state machine 300. This adds robustness against power failures or forced resets.

Further, the steps implemented by state machine 300 being fewer in number, this increases the processing speed.

Various embodiments and variants have been described. The person skilled in the art will understand that certain features of these various embodiments and variants could be combined, and other variants will become apparent to the person skilled in the art. In particular, step 412 may also be implemented by a state machine which is different from state machine 300.

Finally, the practical implementation of the described embodiments and variants is within the abilities of those skilled in the art, based on the indications given above.

What is claimed is:

1. A method of updating a security data stored in a first sector of a non-volatile memory of a microcontroller, a first status being assigned to the first sector, the method comprising the following successive steps:
erasing a content of a second sector of the non-volatile memory, different from the first sector;
writing a new version of the security data into the second sector; and
assigning the first status to the second sector.

2. The method according to claim 1, wherein each sector comprises a plurality of security data.

3. The method according to claim 2, wherein, after the writing the new version of the security data into the second sector, and, before assigning the first status to the second sector, sequentially copying the security data stored in the first sector into the second sector.

4. The method according to claim 3, the first sector and the second sector comprising memory spaces each referenced by an address index; and
the security data of the first sector being each stored in one of the memory spaces of the first sector, and each copied into the second sector based on the memory space of the second sector, having a respective address index corresponding to the address index of the memory space associated with the security data of the first sector to be copied, being blank.

5. The method according to claim 1, wherein a second status is assigned to the first sector once the first status has been assigned to the second sector.

6. The method according to claim 5, wherein, prior to the updating the security data, the first status is assigned to the first sector and the second status is assigned to the second sector.

7. The method according to claim 1, wherein only the first sector assigned with the first status is read.

8. The method of claim 1, further comprising performing the erasing, the writing, and the assigning for each of multiple updating cycles.

9. A microcontroller comprising:
a memory comprising:
a first sector, wherein a first status is to the first sector;
a second sector different from the first sector; and
a security data to be updated stored in the first sector; and
a processor coupled to the memory and configured to cause the microcontroller to successively:
erase a content of the second sector;
write a new version of the security data into the second sector; and
assign the first status to the second sector.

10. The microcontroller according to claim 9, wherein each sector comprises a plurality of security data.

11. The microcontroller according to claim 10, wherein the processor is configured to, after writing the new version of the security data into the second sector and, before assigning the first status to the second sector, sequentially copy the security data stored in the first sector into the second sector.

12. The microcontroller according to claim 11, wherein the copying of the security data from the first sector into the second sector is implemented by a state machine executed by the processor.

13. The microcontroller according to claim 9, wherein the erasing of the content of the second sector is implemented by a memory control circuit as a result of a first software command.

14. The microcontroller according to claim 13, wherein the writing of the new version of the security data into the second sector is implemented by the memory control circuit as a result of a second software command.

15. The microcontroller according to claim 9, wherein a second status is assigned to the first sector once the first status has been assigned to the second sector.

16. The microcontroller according to claim 15, wherein the processor is configured to cause the microcontroller to, prior to the update, assign the first status to the first sector and assign the second status to the second sector.

17. The microcontroller according to claim 15, wherein each sector comprises a space dedicated to storage of the respective status assigned to the sector.

18. The microcontroller according to claim 9, wherein only the first sector assigned with the first status is read.

19. The microcontroller according to claim 9, wherein each security data is a respective encryption key.

20. A system comprising:
a microcontroller comprising:
a memory comprising:
a first sector, wherein a first status is to the first sector;
a second sector different from the first sector; and
a security data to be updated stored in the first sector; and
a processor coupled to the memory and configured to cause the microcontroller to successively:
erase a content of the second sector;
write a new version of the security data into the second sector; and
assign the first status to the second sector; and
an update unit external to the microcontroller and configured to transmit, to the microcontroller and during an update, the new version of the security data.
